(19) United States
(12) Patent Application Publication
(10) Pub. No.: US 2022/0326366 A1
(43) Pub. Date: Oct. 13, 2022

(54) DETECTION DEVICE AND DETECTION SYSTEM

(71) Applicant: CITIZEN WATCH CO., LTD., Tokyo (JP)

(72) Inventor: Hideki SHIMIZU, Saitama (JP)

(21) Appl. No.: 17/642,676

(22) PCT Filed: Aug. 24, 2020
(86) PCT No.: PCT/JP2020/031891

§ 371 Date: Mar. 12, 2022

(30) Foreign Application Priority Data
Sep. 13, 2019 (JP) 2019-167252

(51) Int. Cl. G01S 11/14; H04R 29/00; G01S 3/803; G01S 3/805

(52) U.S. Cl. CPC G01S 11/14; H04R 29/008; G01S 3/803; G01S 3/805

(57) ABSTRACT

A detection device and a detection system that detect a whistle sound to estimate the distance to the sound source are provided. The detection device (1) includes a detector (20) that detects a sound wave; storage (30) that contains characteristic information indicating frequencies of a fundamental and harmonics of a whistle sound and levels of the harmonics relative to the fundamental; a frequency analysis unit (41) that determines a frequency spectrum of a sound wave detected by the detector; a determination unit (45) that determines whether the frequency spectrum has peaks of the fundamental and the harmonics and how many times the peaks of the harmonics from the fundamental exceed a preset minimum level; and a distance estimation unit (46) that estimates a distance to a sound source of a whistle sound detected by the detector, based on a relationship between propagation distances and attenuations of a sound wave as well as information on the levels included in the characteristic information and the result of determination by the determination unit.

### FIELD

The present invention relates to a detection device and a detection system.

### BACKGROUND

An emergency whistle (SOS whistle) for seeking help in a disaster or distress situation is known. For example, it is standard equipment on a life vest and is employed by municipalities. An emergency whistle can produce a large sound with only a light blow, and can be used by a person who has lost strength to cry.

For example, Patent Literature 1 describes an invention of a whistle whose object is to produce a beat including more harmonics of high orders, having a high sound pressure, rising fast, and drawing much attention. For example, Patent Literature 2 and 3 describes inventions to detect a blown whistle by receiving a radio signal emitted from the whistle.

### CITATION LIST

### Patent Literature

Patent Literature 1: Japanese Unexamined Patent Publication No. 2002-108345

Patent Literature 2: Japanese Unexamined Patent Publication No. 2004-264324

Patent Literature 3: Japanese Unexamined Patent Publication No. 2016-180924

### SUMMARY

With aging, the age group of people who search for a sufferer when an emergency whistle is actually blown is becoming higher. An emergency whistle produces a 3.5-kHz sound, which is easiest for adults to recognize. However, since the sense of hearing of a 3.5-kHz sound of people, for example, in their sixties is lower than that of people in their twenties by nearly 30 dB, searchers may fail to hear a whistle sound or to identify the position of the sound source.

It is an object of the present invention to provide a detection device and a detection system that detect a whistle sound to estimate the distance to the sound source.

Provided is a detection device including at least one detector that detects a sound wave; storage that contains characteristic information indicating frequencies of a fundamental and harmonics of a whistle sound and levels of the harmonics relative to the fundamental; a frequency analysis unit (a frequency analyzer) that determines a frequency spectrum of a sound wave detected by the detector; and a determination unit (a determiner) that determines whether the frequency spectrum has peaks of the fundamental and the harmonics and how many times the peaks of the harmonics from the fundamental exceed a preset minimum level. The detection device further includes a distance estimation unit (a distance estimator) that estimates a distance to a sound source of a whistle sound detected by the detector, based on a relationship between propagation distances and attenuations of a sound wave as well as information on the levels included in the characteristic information and the result of determination by the determination unit.

The storage may contain the characteristic information for each of whistle sounds produced by a plurality of types of whistles; the detection device may further include an input unit (an inputter) that enables a user to select a whistle to be detected; and the distance estimation unit may estimate the distance to the sound source, based on information on the levels included in the characteristic information regarding a whistle selected with the input unit and the result of determination by the determination unit.

The detection device may further include a characteristic learning unit (a characteristic learner) that determines the characteristic information regarding a whistle sound detected by the detector, from a frequency spectrum of the whistle sound, and that stores the characteristic information in the storage.

The detection device may further include an indicator that indicates the level of a fundamental included in a sound wave detected by the detector, and a sound collecting hood for increasing detection sensitivity to a sound wave from a particular direction.

The at least one detector may include a plurality of directional detectors oriented in different directions; and the detection device may further include a direction estimation unit (a direction estimator) that estimates the direction of the sound source relative to the detection device, based on a magnitude relationship between levels of fundamentals included in sound waves detected by the respective detectors.

Provided is a detection system including at least one of the above detection devices; and a control terminal capable of communicating with the detection device and configured to estimate the position of the sound source, based on the position of the detection device and the distance estimated by the detection device.

Provided is a detection system including one of the above detection devices, and a moving object equipped with the detection device.

Provided is a detection system including one of the above detection devices; a moving object equipped with the detection device; and a control terminal capable of communicating with the detection device and the moving object and configured to estimate the position of the sound source, based on the position of the detection device and the distance estimated by the detection device.

The control terminal may be capable of writing the characteristic information to the storage of the detection device.

The above detection device and detection system can detect a whistle sound to estimate the distance to the sound source.

### BRIEF DESCRIPTION OF DRAWINGS

FIG. 1 schematically illustrates the configuration of a detection device 1.

FIG. 2 is a functional block diagram of the detection device 1.

FIG. 3 is a graph showing an example of the frequency spectrum of a whistle sound.

FIG. 4 is a graph showing an example of changes in intensity of a whistle sound depending on its propagation distance.

FIGS. 5A to 5C are graphs showing examples of the frequency spectrum of a whistle sound.

FIG. 6 is a diagram for explaining characteristic information stored in storage 30.

FIGS. 7A and 7B schematically illustrate the configuration of a detection device 101 according to a modified example; FIG. 7A is a front view and FIG. 7B is a top view.

FIG. 8 is a functional block diagram of the detection device 101 according to the modified example.

FIGS. 9A to 7C are diagrams for explaining a detection system 4 including detection devices 2.

FIG. 10 is a functional block diagram of the detection device 2.

FIG. 11A schematically illustrates the configuration of a detection system 1000 according to modified example 1; FIG. 11B is a front view of an inboard monitor included in the detection system 1000 according to modified example 1.

FIG. 12 is a functional block diagram of a detection device 102 included in the detection system 1000 according to modified example 1.

FIG. 13 schematically illustrates the configuration of a detection system 2000 according to modified example 2.

FIG. 14 is a functional block diagram of a detection device 103 included in the detection system 2000 according to modified example 2.

FIG. 15 is a flowchart for explaining the steps for the detection system 2000 according to modified example 2 to search for a sufferer.

### DESCRIPTION OF EMBODIMENTS

Detection devices and detection systems will now be described with reference to the attached drawings. However, note that the present invention is not limited to the drawings or the embodiments described below.

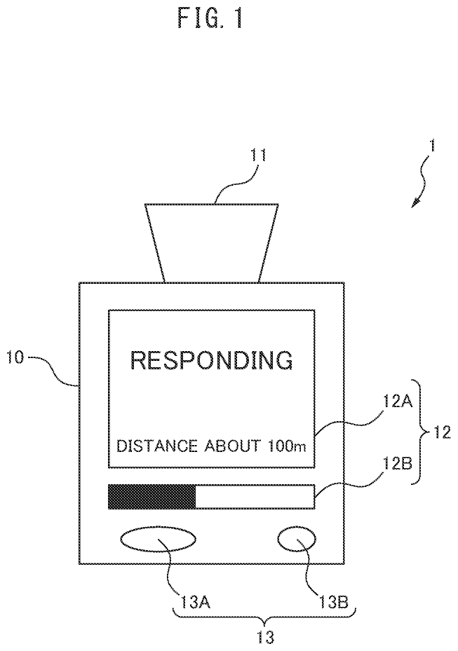

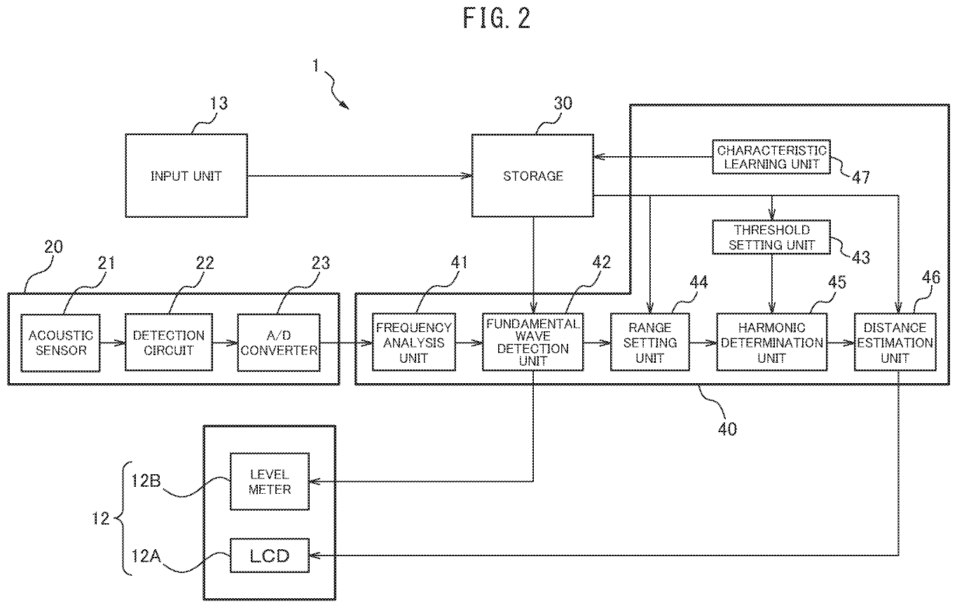

FIG. 1 schematically illustrates the configuration of a detection device 1. The detection device 1 has the functions of detecting a sound produced by an emergency whistle and estimating the approximate distance to the sound source, based on the orders of harmonics of the detected whistle sound. The detection device 1 has a portable-sized case 10 that a searcher can carry; the case 10 includes a sound collecting hood 11, an indicator 12, and an input unit (an inputter) 13. The sound collecting hood 11 gives directivity to an acoustic sensor 21 (see FIG. 2) incorporated in the box-shaped case 10, and is provided on a top surface of the case 10 in the figure.

The indicator 12 is composed of a liquid crystal display (LCD) panel 12A and a level meter 12B, which are disposed on the front surface of the case 10. The LCD 12A shows whether a whistle sound is detected and, if so, the distance to the sound source estimated by the detection device 1. In the illustrated example, the level meter 12B has a bar whose length varies depending on the value to be indicated, and indicates the level of the fundamental (fundamental wave) included in the detected sound wave. The input unit 13 is composed of a start/stop button 13A and a selection button 13B, which are disposed below the indicator 12 on the front surface of the case 10. The start/stop button 13A is used for a user to give instructions to start and stop detecting a whistle sound. The selection button 13B, which is an example of the input unit, is used for the user to select a whistle to be detected from multiple types of whistles.

FIG. 2 is a functional block diagram of the detection device 1. In addition to the indicator 12 and the input unit 13, the detection device 1 includes a detector 20, storage 30, and a controller 40.

The detector 20 is composed of an acoustic sensor 21, a detection circuit 22, and an A/D converter 23. The acoustic sensor 21 is a microphone that can detect audible and inaudible sounds, for example, in the frequency band of 20 Hz to 80 kHz, and outputs a detection signal depending on a detected sound wave to the detection circuit 22. Since the frequency of the fundamental of a typical emergency whistle is 3.5 kHz, the acoustic sensor 21 only has to be able to detect sound waves of frequencies of approximately 3 kHz or more to detect a whistle sound. The sound collecting hood 11 enables the acoustic sensor 21 to detect a sound wave from a particular direction sensitively. The detection circuit 22 converts the detection signal of the acoustic sensor 21 into an analog voice signal. The A/D converter 23 converts it into a digital voice signal and outputs it to the controller 40.

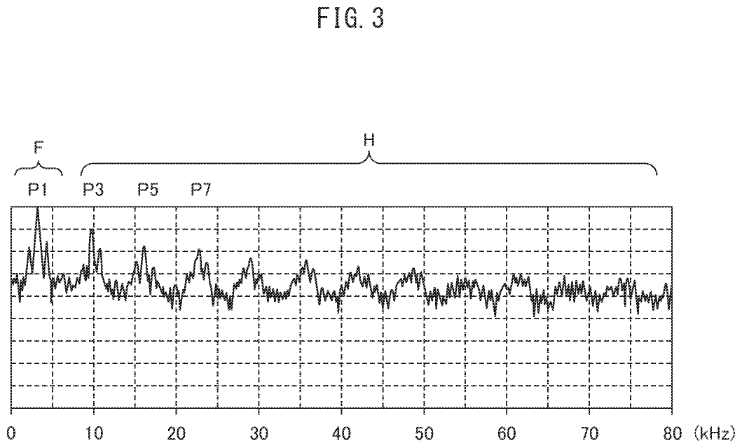

FIG. 3 is a graph showing an example of the frequency spectrum of a whistle sound. The abscissa represents frequency (kHz), and the ordinate represents intensity. The sound produced by a typical emergency whistle is a sound wave including not only a complete sinusoidal component but also a fundamental F and harmonics H (in most cases, odd harmonics) at close range within 1 m of the sound source. Reference symbol P1 indicates the peak of the fundamental F, and reference symbols P3, P5, and P7 indicate the peaks of the harmonics H of the third, fifth, and seventh orders, respectively.

In general, the attenuation A (dB) of a sound pressure depending on the distance from a simple sound source is determined by

A=20 log₁₀ (r/r0) Expression 1

where r0 and r are the sound pressures at a reference point and at a distance of interest, respectively. The coefficient C of attenuation of a sound pressure per 1 m caused by air in the case of a frequency f (Hz), an atmospheric temperature of 20 to 30 degrees C., and a humidity of 60 to 70% is as follows.

C ≈1×10⁻¹¹×f² Expression 2

It depends on the frequency.

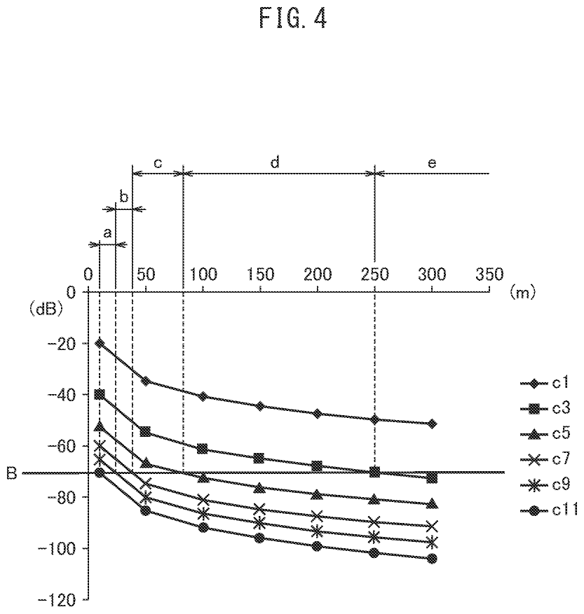

FIG. 4 is a graph showing an example of changes in intensity of a whistle sound depending on its propagation distance. The abscissa represents distance (m) from the sound source, and the ordinate represents relative intensity (dB). Applying Expressions 1 and 2 to the harmonics of an actual emergency whistle yields changes in intensity of the fundamental and the harmonics depending on their propagation distances as shown in FIG. 4. The curve c1 is a plot of the fundamental, and the curves c3, c5, c7, c9, and c11 are plots of the harmonics of the third, fifth, seventh, ninth, and eleventh orders, respectively. Since the relationship between the levels of the fundamental and the harmonics of a whistle sound generally varies depending on the types of whistles, the vertical positions of the curves may be changed in the case of a type of whistle different from that in the illustrated example. However, at the same frequency, atmospheric temperature, and humidity, the changes in intensity are similar to those shown in FIG. 4 even in the case of a different type of whistle.

Thus the approximate distance to the sound source can be estimated by determining how many times the peaks of the harmonics from the fundamental exceed a noise level of the detector 20 (the minimum level such that peaks of the frequency spectrum can be identified) and are detected. For example, when the minimum level B is −70 dB, the graph of FIG. 4 suggests that the distance to the sound source is

approximately 10 m (section a) if the harmonics of up to the ninth order are detected,

approximately 30 m (section b) if the harmonics of up to the seventh order are detected,

approximately 50 m (section c) if the harmonics of up to the fifth order are detected,

approximately 100 to 200 m (section d) if the harmonics of up to the third order are detected, and

250 m or greater (section e) if only the fundamental is detected.

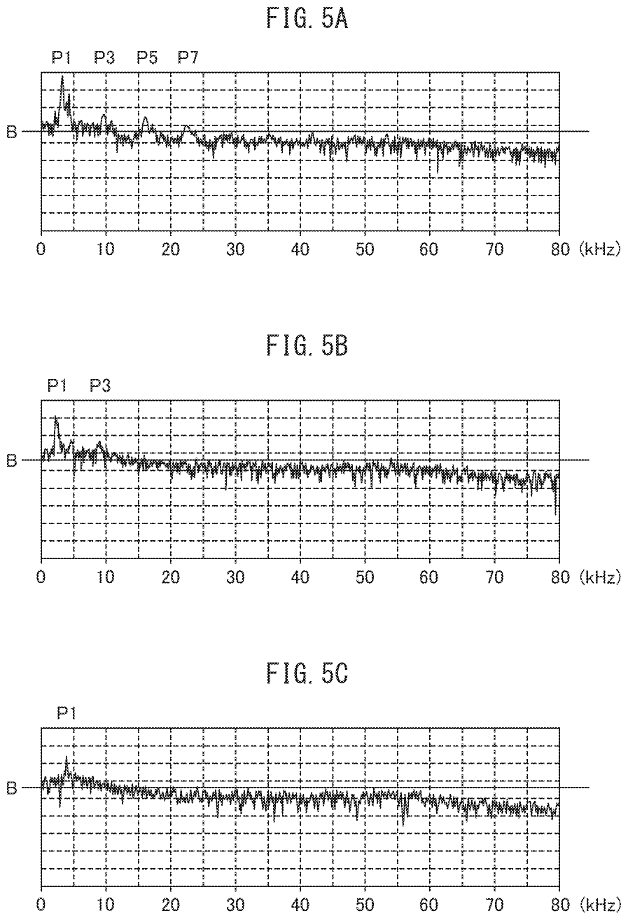

FIGS. 5A to 5C are graphs showing examples of the frequency spectrum of a whistle sound. These frequency spectra are of the same whistle sound, but the distances to the sound source are different. The example of FIG. 5A suggests that the distance to the sound source is approximately 30 m (section b in FIG. 4) because the peaks P1, P3, P5, and P7 of the fundamental to the seventh harmonics exceed the minimum level B (detected). The example of FIG. 5B suggests that the distance to the sound source is approximately 100 to 200 m (section d in FIG. 4) because the peaks P1 and P3 of the fundamental and the third harmonics exceed the minimum level B. The example of FIG. 5C suggests that the distance to the sound source is 250 m or greater (section e in FIG. 4) because only the peak P1 of the fundamental exceeds the minimum level B.

The storage 30 is constructed from, for example, a semiconductor memory, and contains information (data) necessary for the operation of the detection device 1. In particular, the storage 30 prestores basic data of the frequency spectrum of a sound of a target whistle detected, for example, at a position 1 m away from the sound source when the whistle is blown. This basic data includes the frequencies of the fundamental and the harmonics, the level differences (or ratios) between the fundamental and the harmonics, and the minimum level (noise level) of detection. This data will hereafter be referred to as characteristic information. The detection device 1 is based on the premise that the characteristic information regarding a whistle to be blown is known, because the types of distributed emergency whistles are chosen in most cases, for example, on a municipality-by-municipality basis. The distance from the sound source to the detection position to obtain characteristic information is not limited to 1 m and can be chosen as desired. However, the detection position is preferably near the sound source.

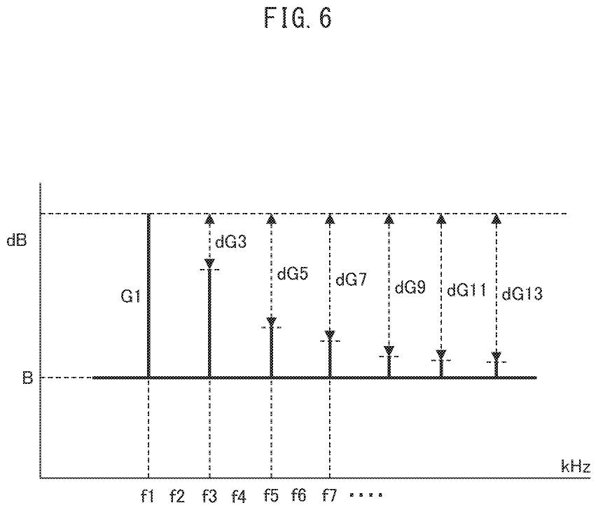

FIG. 6 is a diagram for explaining characteristic information stored in the storage 30. The abscissa represents frequency (kHz), and the ordinate represents relative intensity (dB). Reference symbol f1 indicates the frequency of the fundamental, and reference symbols f2 to f7 the frequencies of the harmonics of the second to seventh orders, respectively; reference symbol G1 indicates the level of the fundamental, and reference symbols dG3, dG5, . . . , dG13 the level differences between the fundamental and the harmonics of the third, fifth, . . . , thirteenth orders, respectively; reference symbol B indicates the minimum level. The storage 30 contains these values. Regarding both odd and even harmonics, the values of the frequencies fn and the level differences dGn relative to the fundamental are defined (n=2, 3, . . . ) because even harmonics as well as odd harmonics may be included depending on whistles. Up to which order of the harmonics the data of the frequencies and the level differences is stored may be appropriately determined as necessary.

The storage 30 may contain the characteristic information for each of whistle sounds produced by a plurality of types of whistles. The storage 30 may contain the characteristic information shown in FIG. 6 in association with the model numbers (identifying information) of whistles because the frequencies of the fundamental and the harmonics generally vary depending on the types of whistles. However, the minimum level B may be the same value regardless of the types of whistles.

The controller 40 is configured as a control circuit of a microcomputer including a CPU, a RAM, and a ROM, and controls the operation of the detection device 1. As its functional blocks implemented by the microcomputer, the controller 40 includes a frequency analysis unit (a frequency analyzer) 41, a fundamental detection unit (a fundamental detector) 42, a threshold setting unit (a threshold setter) 43, a range setting unit (a range setter) 44, a harmonic determination unit (a harmonic determiner) 45, a distance estimation unit (a distance estimator) 46, and a characteristic learning unit (a characteristic learner) 47.

The frequency analysis unit 41 performs fast Fourier transform (FFT) on a digital voice signal obtained from the A/D converter 23 to determine the frequency spectrum of a sound wave detected by the detector 20.

The fundamental detection unit 42 scans a certain range centered at the frequency f1 of the fundamental in the frequency spectrum determined by the frequency analysis unit 41, e.g., the range of f1−0.5 (kHz)≤f≤f1+0.5 (kHz), to check whether there is a peak exceeding the minimum level B. The size of the scanned range is not limited to this example, and can be set appropriately. If a peak is detected within the scanned range, the fundamental detection unit 42 instructs the harmonic determination unit 45 to execute a process and causes the level meter 12B to indicate the level of the detected peak. If no peak is detected within the scanned range, the fundamental detection unit 42 causes the LCD 12A to show the fact that the target whistle is not detected.

The threshold setting unit 43 obtains the minimum level B of detection for a whistle selected by a user pushing the selection button 13B (or a predetermined whistle if no selection is made) from the storage 30. The range setting unit 44 obtains the values of the frequencies f2, f3, . . . of the harmonics stored for the selected (or predetermined) whistle from the storage 30, and sets, for example, the range of fn−0.5 (kHz)≤f≤fn+0.5 (kHz) (n=2, 3, . . . ) as a detection range. The size of this scanned range can also be set appropriately, and may differ from order to order of the harmonics.

The harmonic determination unit 45 scans the range of fn−0.5 (kHz)≤f≤fn+0.5 (kHz), for each n=2, 3, . . . , in the frequency spectrum determined by the frequency analysis unit 41 to check how many times the peaks of the harmonics from the fundamental exceed the minimum level B. The fundamental detection unit 42 and the harmonic determination unit 45 are an example of the determination unit (determiner).

The distance estimation unit 46 estimates the distance to the sound source, based on the level G1 of the fundamental and the level differences dGn between the fundamental and the harmonics stored for the selected (or predetermined) whistle as well as the result of determination by the harmonic determination unit 45. The left endpoints of the curves in the graph of FIG. 4 are determined from the values of the level G1 of the fundamental and the level differences dGn (i.e., the values of the levels of the fundamental and the harmonics at a distance of 1 m from the sound source). Those curves of changes in intensity of the fundamental and the harmonics depending on their propagation distances which extend from these points are determined by Expressions 1 and 2. Thus the distance estimation unit 46 determines the relationship between propagation distances and attenuations regarding the fundamental and the harmonics of a target whistle similar to the graph of FIG. 4, using Expressions 1 and 2, and determines the approximate distance to the sound source, depending on how many times the peaks of the harmonics from the fundamental exceed the minimum level B. The distance estimation unit 46 then causes the LCD 12A to show the fact that the target whistle has been detected and the estimated distance.

The characteristic learning unit 47 determines (learns) the characteristic information in FIG. 6 regarding a whistle sound detected by the detector 20 at a position, for example, 1 m away from the sound source, from the frequency spectrum of the whistle sound, and stores it in the storage 30. A learning button may be provided on the case 10; and the characteristic learning unit 47 may store characteristic information regarding a new whistle sound in the storage 30 when this button is pushed by a user. The characteristic information shown in FIG. 6 is not necessarily prestored in the storage 30. When the detection device 1 is used, the characteristic learning unit 47 may learn a whistle sound produced by a searcher with a whistle of the same type as the detection target and detected by the detector 20 and stores the characteristic information in the storage 30.

When using the detection device 1, a user (searcher) first presses the start/stop button 13A to start the detection device 1, rotates 360 degrees slowly with the case 10 held horizontally in his/her hand, and checks whether indication of the level meter 12B oscillates. If indication of the level meter 12B oscillates, the user further directs the sound collecting hood 11 (the acoustic sensor 21) in the direction where the level meter 12B indicates the maximum. The user then moves in the direction of the sound collecting hood 11 with the distance displayed on the LCD 12A as a guide, checks that the indicated distance decreases during movement, and searches around closely when the indicated distance falls below several meters. If the indicated distance does not decrease even after movement, the user tries again from a check of the direction where indication of the level meter 12B oscillates.

The detection device 1 can identify the direction of the source of a whistle sound and the distance thereto, and facilitates identifying the place of a sufferer. Since the frequency spectrum of a detected sound wave is almost unchanged even through obstacles such as rubble, the distance to the sound source can be estimated without being affected by obstacles. Various types of whistle sounds can be detected by prestoring characteristic information regarding multiple types of whistles in the storage 30 or by learning characteristic information regarding a new whistle sound.

The case 10 may be equipped with a measurement unit that measures ambient temperature and humidity (a temperature sensor and a humidity sensor) because the attenuation coefficient C in Expression 2 varies depending on atmospheric temperature and humidity. In this case, the distance to the sound source can be estimated more accurately by correcting the curves of changes in intensity in FIG. 4 according to attenuation characteristics of a sound wave propagating through the air at the measured temperature and humidity.

An emergency whistle produces an audible sound, but the detection device 1 can also detect the source of an inaudible sound similarly by appropriately setting the frequencies f1, f2, . . . of the fundamental and the harmonics. For example, the detection device 1 can also detect a sound of a silent whistle, which produces a nearly ultrasonic sound wave inaudible to the human ear, similarly.

### MODIFIED EXAMPLE

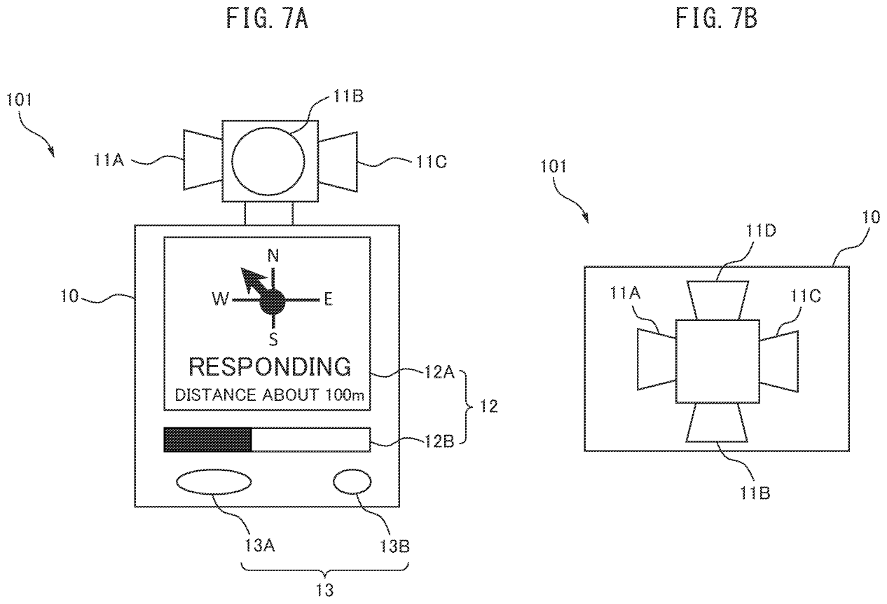

FIGS. 7A and 7B schematically illustrate the configuration of a detection device 101 according to a modified example. FIG. 7A is a front view of the detection device 101, and FIG. 7B is a top view thereof. The detection device 101 according to the modified example includes multiple acoustic sensors for detecting whistle sounds from different directions around the detection device 101, and differs from the detection device 1 in this respect. The other components of the detection device 101 according to the modified example are the same as those of the detection device 1.

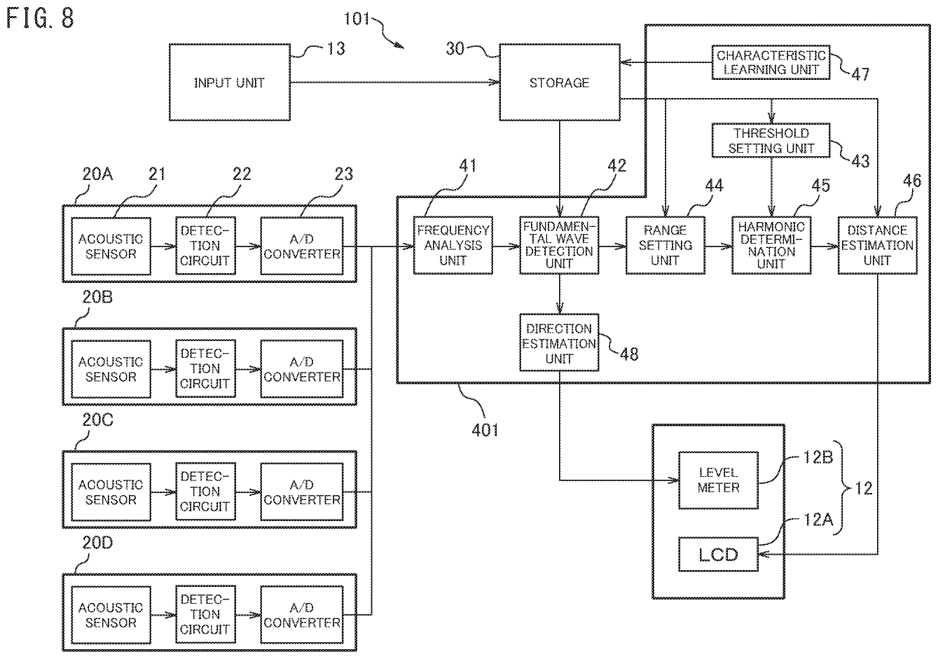

The detection device 101 includes four sound collecting hoods (11A, 11B, 11C, and 11D) and a box-shaped case 10. The four sound collecting hoods (11A, 11B, 11C, and 11D) give directivity to four acoustic sensors 21 (see FIG. 8), and are provided on a top surface of the case 10 in the figure so as to open in all four directions. FIGS. 7A and B show an example in which four sound collecting hoods including acoustic sensors are provided; but the number is not limited to this example and may be two, three, or five or more.

FIG. 8 is a functional block diagram of the detection device 101. The detection device 101 includes an indicator 12, an input unit 13, four detectors (20A, 20B, 20C, and 20D), storage 30, and a controller 401. The four acoustic sensors 21 of the detectors (20A, 20B, 20C, and 20D) are disposed at intervals of 90 degrees to detect whistle sounds from four directions around the detection device 101.

The controller 401 has the same configuration and functions as the controller 40 of the detection device 1, except that it includes a direction estimation unit (a direction estimator) 48. In the illustrated example, the frequency analysis unit 41 performs fast Fourier transform on digital voice signals obtained from the A/D converters 23 of the detectors (20A, 20B, 20C, and 20D) to determine the frequency spectra of four sound waves detected by these detectors. The fundamental detection unit 42, the threshold setting unit 43, the range setting unit 44, the harmonic determination unit 45, and the distance estimation unit 46 estimate the distance to the source of the sound waves detected by the detectors (20A, 20B, 20C, and 20D), similarly to the detection device 1.

The direction estimation unit 48 estimates the direction of the sound source relative to the detection device 101, based on the magnitude relationship between the levels of the fundamentals detected by the fundamental detection unit 42 from the frequency spectra of the four sound waves determined by the frequency analysis unit 41 and the directions of the acoustic sensors of the detectors (20A, 20B, 20C, and 20D). To determine the directions of the acoustic sensors, for example, the sound collecting hood 11D of the detector 20D may be set toward the north, or a magnetic sensor for determining the direction may be provided. If the detected direction is the northwest, the LCD 12A indicates the direction with an arrow and shows the fact that there is a response (“Responding”) and the estimated distance to the sound source (e.g., “Distance 100 m”), as shown in FIG. 7A. Additionally, the level meter 12B indicates the maximum of the levels of the fundamentals included in the sound waves detected by the detectors (20A, 20B, 20C, and 20D).

The position of the sound source need not be determined from the magnitude relationship between the levels of the fundamentals, and may be determined by the beam forming method. If the beam forming method is used, multiple acoustic sensors may be arrayed so as to face in the same direction. According to the beam forming method, the position of the sound source can be estimated using the fact that, when the acoustic sensors are at different distances from the sound source, a sound wave arrives at the acoustic sensors at different times and the difference between the arrival times at the acoustic sensors is a function of the position of the sound source.

The sound collecting hoods (11A to 11D) including acoustic sensors, which are combined with the case 10 in the example shows in FIG. 7A, may be detachably attached to the case 10 and connected with wires or by wireless. The detachably attached sound collecting hoods (11A to 11D) including acoustic sensors enable the acoustic sensors to be disposed anywhere, e.g., at a place inaccessible to a user, extending the search area of the sound source.

The detection device according to the modified example, which includes acoustic sensors oriented in all directions, can save a user from rotating the acoustic sensors around to search for the sound source.

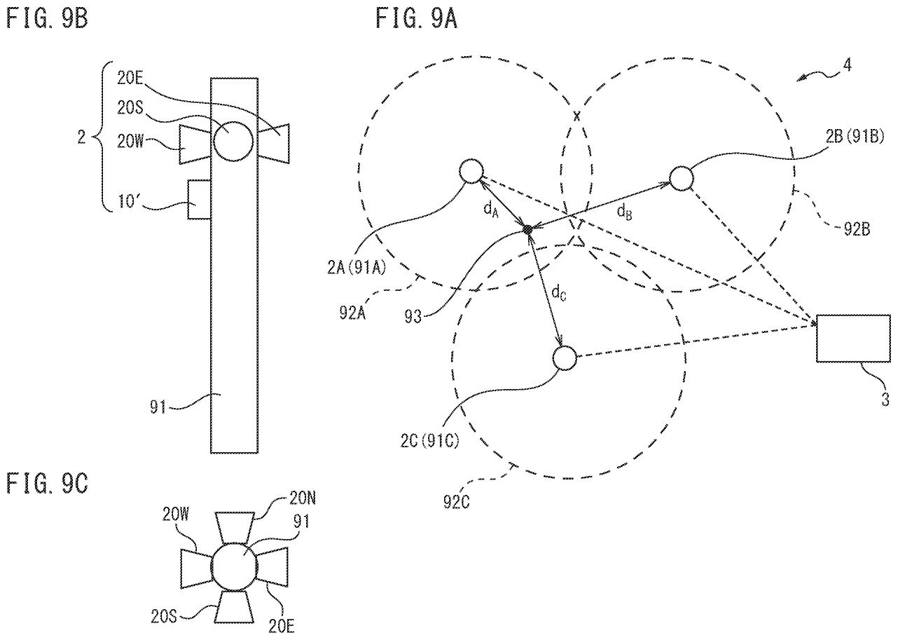

FIG. 9A is a side view showing an example of a detection system 4 including detection devices 2. The detection system 4 is composed of detection devices 2A to 2C and a control terminal 3. The detection devices 2A to 2C each have the same functions as the detection device 1, and are mounted on respective poles 91A to 91C, placed at intervals of 300 m to 1 km, to broadcast disaster radio of a municipality. Broken lines 92A to 92C indicate the areas covered by the poles 91A to 91C and the detection devices 2A to 2C, respectively. These are assumed to be the ranges of broadcasts from the poles 91A to 91C and of detection of a sound source by the detection devices 2A to 2C. The number of detection devices, which is three in the illustrated example, is not limited to any particular number and may be one or greater.

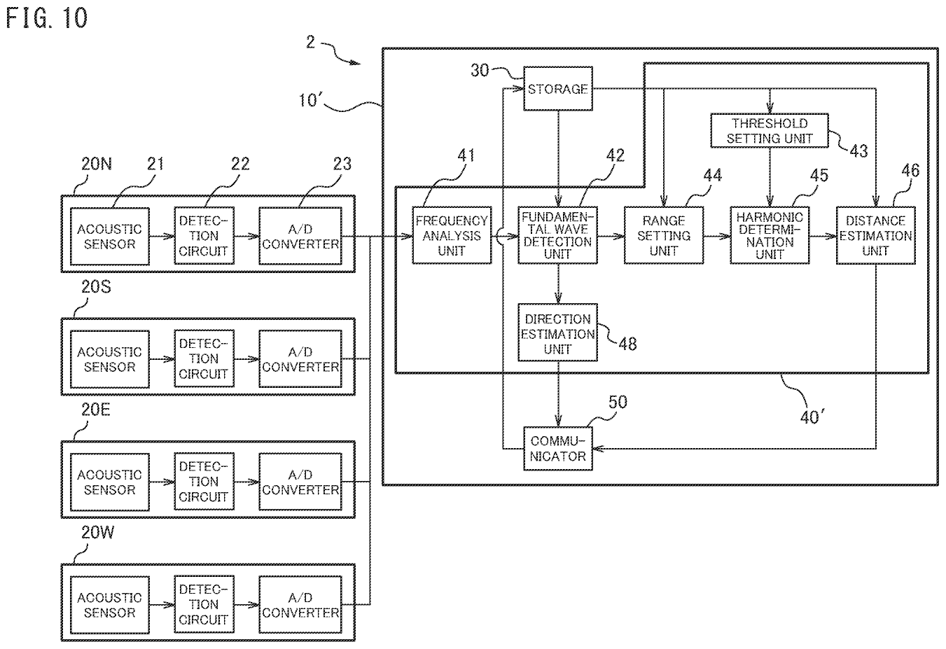

FIGS. 9B and 9C are a side view and a top view of a pole 91 for broadcasting mounted with a detection device 2. FIG. 10 is a functional block diagram of the detection device 2. The detection devices 2A to 2C have the same configuration, and are simply referred to as detection devices 2 unless they are distinguished. The poles 91A to 91C also have the same structure, and are thus simply denoted by reference symbol 91 in FIGS. 9B and 9C.

Each detection device 2 includes a body 10′ and detectors 20N, 20S, 20E, and 20W. The body 10′ includes storage 30, a controller 40′, and a communicator 50. Each detection device 2 has the same configuration as the detection device 1, except that the detectors, the number of which is increased to four, are separated from the body 10′ and that the detection device 2 includes a communicator 50 instead of the indicator 12 and the input unit 13. The detection devices 2 (2A to 2C) use two-way communication (an answerback function) of disaster radio to transmit identifying information (ID) on the respective poles 91 and the result of detection of a whistle sound to the control terminal 3.

For example, the body 10′ is fixed on the side surface of the pole 91; the detectors 20N, 20S, 20E, and 20W are mounted inside speakers of the pole 91 facing north, south, east, and west, respectively, and integrated into the speakers. Since they are close to the speakers, the detectors 20N, 20S, 20E, and 20W may stop operating while the speakers are outputting a broadcast, to prevent erroneous detection. However, unlike the illustrated example, the detectors 20N, 20S, 20E, and 20W may be separated from the speakers of the pole 91, and the number of detectors may be other than four. The detectors 20N, 20S, 20E, and 20W are each the same as the detector 20, and have directivity and face in different directions by being mounted inside the speakers of the pole 91. For example, the detectors 20N, 20S, 20E, and 20W are assumed to face north, south, east, and west, respectively.

The controller 40′ has the same configuration and functions as the controller 40, except that it includes a direction estimation unit 48 instead of the characteristic learning unit 47. In the illustrated example, the frequency analysis unit 41 performs fast Fourier transform on digital voice signals obtained from the A/D converters 23 of the detectors 20N, 20S, 20E, and 20W to determine the frequency spectra of four sound waves detected by these detectors. However, since fast Fourier transform requires a certain throughput, each of the detectors 20N, 20S, 20E, and 20W may have the function of the frequency analysis unit 41 if it is difficult for the single controller 40′ to process four channels simultaneously. The fundamental detection unit 42, the threshold setting unit 43, the range setting unit 44, the harmonic determination unit 45, and the distance estimation unit 46 estimate the distance to the source of the sound waves detected by the detectors 20N, 20S, 20E, and 20W, in the same manner as described above.

The direction estimation unit 48 estimates the direction of the sound source relative to the detection device 2, based on the magnitude relationship (permutation) of the levels of the fundamentals detected by the fundamental detection unit 42 from the frequency spectra of the four sound waves determined by the frequency analysis unit 41. The levels of the fundamentals included in the sound waves detected by the detectors 20N, 20S, 20E, and 20W are denoted by Vn, Vs, Ve, and Vw, respectively. The direction estimation unit 48 estimates the sound source to be, for example, north-northwest if Vn>Vw>Ve>Vs, north if Vn>Vw ≈ Ve>Vs, and southeast if Ve ≈ Vs>Vn ≈ Vw. To this end, the direction estimation unit 48 may define a certain determination range of the level of the fundamental, and determine the magnitude, depending on whether the level difference is within this range.

The communicator 50 transmits the distance to the sound source estimated by the distance estimation unit 46 and the direction to the sound source estimated by the direction estimation unit 48 together with the identifying information on the corresponding pole 91 to the control terminal 3.

The control terminal 3 is a device, such as a personal computer (PC), placed, for example, in a control center of a municipality, and receives the results of detection of a whistle sound from the detection devices 2A to 2C to estimate the position of the source of the whistle sound, based on these results of detection and the positions where the detection devices 2A to 2C are placed. For example, as shown in FIG. 9A, assume that the results of detection by the detection devices 2A, 2B, and 2C are a distance d_{A} in the southeast, a distance d_{B} in the west-southwest, and a distance d_{C} in the north-northwest, respectively (assume that the upper side of FIG. 9A is the north). In this case, the control terminal 3 determines that the whistle to be detected is located at the position indicated by reference symbol 93 where the arrows extended in these directions from the respective detection devices 2A to 2C cross. In this way, the position of the source of a whistle sound can be monitored over a wide area. The detection system 4 can detect a whistle sound produced by, for example, a woman or a child, and be used for preventing crimes, such as molestation.

Since the types of distributed whistles differ from municipality to municipality, the control terminal 3 may transmit the characteristic information regarding a whistle to be detected, i.e., information on the frequencies of the fundamental and the harmonics, the level differences or ratios between the fundamental and the harmonics, and the minimum level of detection to the detection devices 2. In this case, the communicator 50 of each detection device 2 receives the characteristic information regarding a whistle to be detected from the control terminal 3, and the controller 40′ stores the received data in the storage 30. In this way, the control terminal 3 may write the characteristic information to the storage 30 of each detection device 2.

### Modified Example 1 of the Detection System

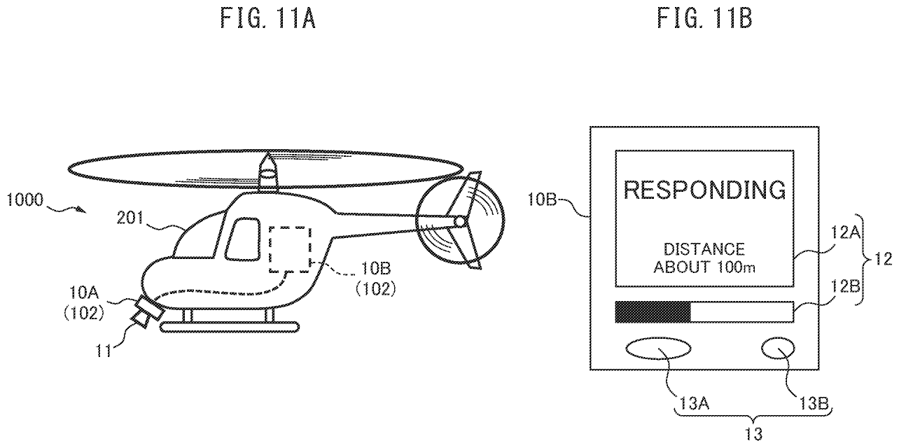

The following describes a detection system 1000 according to modified example 1. FIG. 11A schematically illustrates the configuration of a detection system 1000 according to modified example 1; FIG. 11B is a front view of an inboard monitor 10B included in the detection system 1000 according to modified example 1.

The detection system 1000 according to modified example 1 includes a detection device 102 and a helicopter 201, which is a moving object equipped with the detection device 102. The detection device 102 includes a body case 10A mounted outside (e.g., on the bottom of) the helicopter 201, and an inboard monitor 10B. The body case 10A is provided with a sound collecting hood 11 including an acoustic sensor. The sound collecting hood 11 is disposed with its opening facing the ground. A whistle sound produced from a sufferer can be collected by the sound collecting hood 11 and detected by the acoustic sensor.

The body case 10A is wired to the inboard monitor 10B. Whether the device is responding to a whistle sound collected by the sound collecting hood 11 and the distance from the helicopter 201 to the sound source are displayed on an LCD 12A, and the level of the detected sound wave is indicated by a level meter 12B. The reason the body case 10A is wired to the inboard monitor 10B is that wireless cannot be used for crewed flight because of the air law. A user in the helicopter 201 can check display on the inboard monitor 10B to monitor the presence or absence of a whistle sound produced from a sufferer.

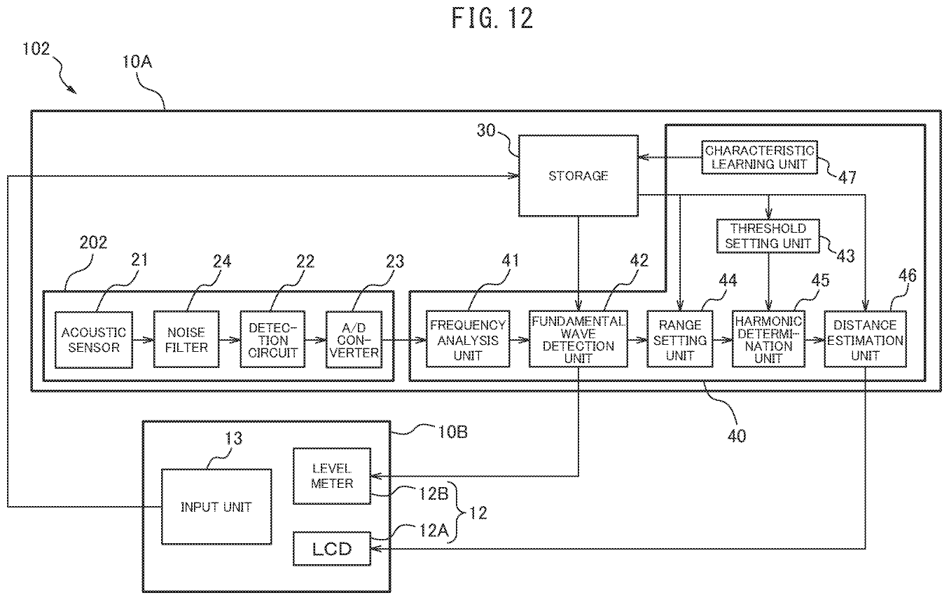

FIG. 12 shows a functional block diagram of the detection device 102 included in the detection system 1000 according to modified example 1. The body case 10A includes a detector 202, storage 30, and a controller 40. The detector 202 includes a noise filter 24 as well as the components of the detector 20 of the detection device 1. The helicopter 201 produces relatively large noise during flight mainly from its main rotor and tail rotor. It is reported that, of the frequency band of this noise, frequency bands of high sound pressure levels are concentrated in the range of 1 kHz or less. To remove such low-frequency noise, the detector 20 is preferably provided with a noise filter 24. The noise filter 24 can remove low-frequency noise, which is the main part of the noise produced by the helicopter 201, from the sound wave detected by the acoustic sensor 21. Thus the detection device 102 mounted on the helicopter 201 can detect a whistle sound even during flight of the helicopter 201.

The moving object included in the detection system 1000 according to modified example 1 is not limited to the helicopter described above, and may be a flying object, such as an airplane or an airship, or another moving object.

The detection system 1000 according to modified example 1 enables a search for a sufferer from the sky and thus an efficient search. Additionally, a sufferer can be rapidly rescued simultaneously with the discovery of the sufferer based on a whistle sound produced from him/her.

### Modified Example 2 of the Detection System

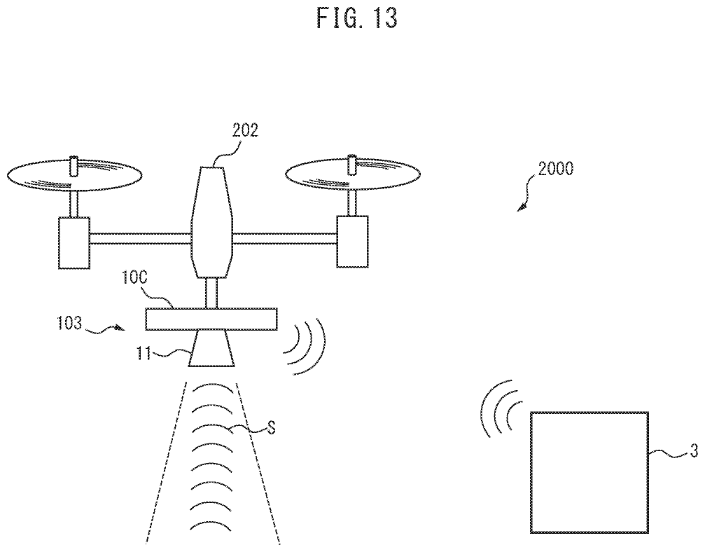

The following describes a detection system 2000 according to modified example 2. FIG. 13 schematically illustrates the configuration of a detection system 2000 according to modified example 2. The detection system 2000 according to modified example 2 is characterized by including a detection device 103, a drone 202, which is a moving object equipped with the detection device 103, and a control terminal 3. The control terminal 3 is capable of communicating with the drone 202, which is a moving object, and the detection device 103, and configured to estimate the position of a sound source, based on the position of the detection device 103 and the distance estimated by the detection device 103.

The detection device 103 has a body case 10C disposed on the bottom of the drone 202. The body case 10C is provided with a sound collecting hood 11 whose opening faces the ground and with which a whistle sound S from the ground is detected.

The drone 202 has a GPS function, communicates with the control terminal 3, and detects a whistle sound produced by a sufferer in a region designated by the control terminal 3.

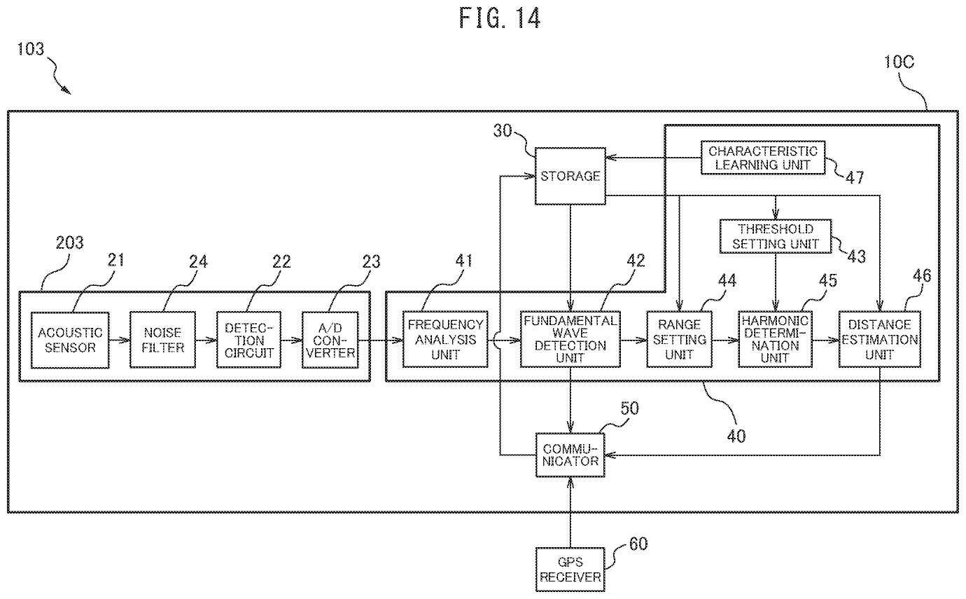

FIG. 14 shows a functional block diagram of the detection device 103 included in the detection system 2000 according to modified example 2. The detection device 103 includes a GPS receiver 60 in addition to the body case 10C. The GPS receiver 60 is mounted on the drone 202 from the beginning. The body case 10C includes a detector 203, storage 30, a controller 40, and a communicator 50.

The detector 203 includes a noise filter 24 for removing noise produced by rotors of the drone 202, similarly to the detection device 102 included in the detection system 1000 according to modified example 1. The noise filter 24 can remove low-frequency noise, which is the main part of the noise produced by the drone 202, from the sound wave detected by the acoustic sensor 21. Thus the detection device 103 mounted on the drone 202 can detect a whistle sound even during flight of the drone 202.

The communicator 50 transmits the distance to the sound source estimated by the distance estimation unit 46 and positional information on the drone 202 received by the GPS receiver 60 to the control terminal 3. Since the sufferer is located near the position where the drone 202 has detected a whistle sound, a region where the sufferer is probably located can be estimated from positional information received by the GPS receiver 60. The drone 202 may be further equipped with a camera (not shown), capture an image of the ground at the time of detection of a whistle sound with the camera, and transmit the image data and the positional information to the control terminal 3.

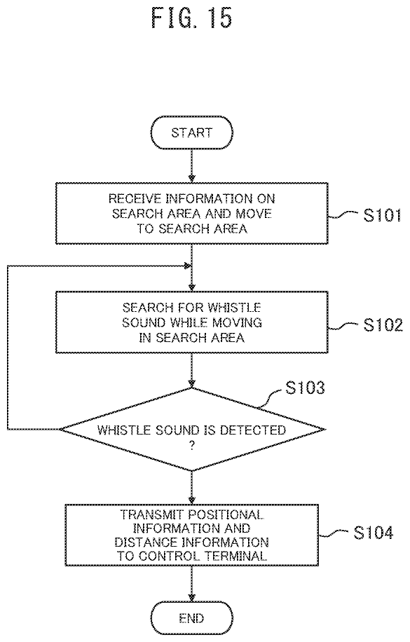

The following describes the steps for searching for a sufferer with the drone 202. FIG. 15 shows a flowchart for explaining the steps for the detection system 2000 according to modified example 2 to search for a sufferer. The drone 202 receives instructions from the control terminal 3, searches for a sufferer, and transmits the result to the control terminal 3.

First, in step S101, the communicator 50 of the drone 202 receives information on a search area of the sufferer transmitted from the control terminal 3, and the drone 202 moves to the designated search area with reference to positional information received by the GPS receiver 60.

Next, in step S102, while moving in the search area, the drone 202 detects a sound collected by the sound collecting hood 11 with the acoustic sensor 21 to detect a whistle sound produced from the sufferer.

Next, in step S103, the controller 40 of the drone 202 determines whether a whistle sound is detected. If it is determined that no whistle sound is detected, the process returns to step S102 and the drone continues searching for a whistle sound while moving in the search area.

If it is determined that a whistle sound is detected in step S103, the fundamental detection unit 42, the threshold setting unit 43, the range setting unit 44, the harmonic determination unit 45, and the distance estimation unit 46 estimate the distance to the source of the sound wave detected by the detector 202, similarly to the detection device 1.

Next, in step S104, the drone 202 transmits information on the position of the drone 202 and on the distance to the sound source at the time of detection of the whistle sound to the control terminal 3. The control terminal 3 assumes that the sufferer is located in an area based on the position of the drone 202 at the time of detection of the whistle sound and the distance to the sound source; an operation to rescue the sufferer can be performed there. The drone 202 preferably further includes an atmospheric pressure sensor for estimating its height from the ground. Assuming that the position coordinates on the ground of the drone 202 at the time of detection of a whistle sound are (x₀, y₀) and that the distance to the sound source is d [m] when the drone 202 is at a height h [m] from the ground, the distance x [m] from the position on the ground of the drone 202 to the sound source is calculated by x=√(d²−h²). Thus the area where the sufferer is located can be estimated to be within the radius x [m] of the coordinates (x₀, y₀).

The drone 202 may be further equipped with a camera, capture an image of the ground at the time of detection of a whistle sound with the camera, and transmit it to the control terminal 3. Since the image of the ground at the time of detection of a whistle sound probably represents a sufferer, the condition of the sufferer can be grasped from his/her image, which enables an appropriate rescue operation.

The moving object included in the detection system 2000 according to modified example 2 is not limited to the drone described above, and may be a search robot that can travel in mountains or other areas, or another moving object.

The detection system 2000 according to modified example 2 enables a search for a sufferer from the sky even in a region inaccessible to a helicopter or even under dangerous environment, and thus enables a safe and efficient search for the sufferer.

The above description has been given by taking a whistle as an example of a tool that produces a fundamental and harmonics. However, the present invention can also be applied similarly to another tool that produces a fundamental and harmonics, such as a dog whistle.

1. A detection device comprising:
at least one detector that detects a sound wave;
storage that contains characteristic information indicating frequencies of a fundamental and harmonics of a whistle sound and levels of the harmonics relative to the fundamental;
a frequency analysis unit that determines a frequency spectrum of a sound wave detected by the detector;
a determination unit that determines whether the frequency spectrum has peaks of the fundamental and the harmonics and how many times the peaks of the harmonics from the fundamental exceed a preset minimum level; and
a distance estimation unit that estimates a distance to a sound source of a whistle sound detected by the detector, based on a relationship between propagation distances and attenuations of a sound wave as well as information on the levels included in the characteristic information and the result of determination by the determination unit.

2. The detection device according to claim 1, wherein the storage contains the characteristic information for each of whistle sounds produced by a plurality of types of whistles,
the detection device further comprises an input unit that enables a user to select a whistle to be detected, and
the distance estimation unit estimates the distance, based on information on the levels included in the characteristic information regarding a whistle selected with the input unit and the result of determination by the determination unit.

3. The detection device according to claim 1, further comprising a characteristic learning unit that determines the characteristic information regarding a whistle sound detected by the detector, from a frequency spectrum of the whistle sound, and that stores the characteristic information in the storage.

4. The detection device according to claim 1, further comprising:
an indicator that indicates the level of a fundamental included in a sound wave detected by the detector; and
a sound collecting hood for increasing detection sensitivity to a sound wave from a particular direction.

5. The detection device according to claim 1, wherein the at least one detector comprises a plurality of directional detectors oriented in different directions, and
the detection device further comprises a direction estimation unit that estimates the direction of the sound source relative to the detection device, based on a magnitude relationship between levels of fundamentals included in sound waves detected by the respective detectors.

6. A detection system comprising:
at least one detection device according to claim 1; and
a control terminal capable of communicating with the detection device and configured to estimate the position of the sound source, based on the position of the detection device and the distance estimated by the detection device.

7. The detection system according to claim 6, wherein the control terminal is capable of writing the characteristic information to the storage of the detection device.

8. A detection system comprising:
a detection device according to claim 1; and
a moving object equipped with the detection device.

9. A detection system comprising:
a detection device according to claim 1;
a moving object equipped with the detection device; and
a control terminal capable of communicating with the detection device and configured to estimate the position of the sound source, based on the position of the detection device and the distance estimated by the detection device.

10. A detection method comprising:
detecting, by a detector, a sound wave;
containing, by a storage, characteristic information indicating frequencies of a fundamental and harmonics of a whistle sound and levels of the harmonics relative to the fundamental;
determining, by a frequency analysis unit, a frequency spectrum of a sound wave detected by the detector;
determining, by a determination unit, whether the frequency spectrum has peaks of the fundamental and the harmonics and how many times the peaks of the harmonics from the fundamental exceed a preset minimum level; and
estimating, by a distance estimation unit, a distance to a sound source of a whistle sound detected by the detector, based on a relationship between propagation distances and attenuations of a sound wave as well as information on the levels included in the characteristic information and the result of determination by the determination unit.

11. The detection method according to claim 10, further comprising:
containing, by the storage, the characteristic information for each of whistle sounds produced by a plurality of types of whistles,
enabling, by an input unit, a user to select a whistle to be detected a detection device, and
estimating, by the distance estimation unit, the distance, based on information on the levels included in the characteristic information regarding a whistle selected with the input unit and the result of determination by the determination unit.

12. The detection method according to claim 10, further comprising determining, by a characteristic learning unit, the characteristic information regarding a whistle sound detected by the detector, from a frequency spectrum of the whistle sound, and that stores the characteristic information in the storage.

13. The detection method according to claim 10, further comprising:
indicating, by an indicator, the level of a fundamental included in a sound wave detected by the detector; and
increasing, by a sound collecting hood, detection sensitivity to a sound wave from a particular direction.

14. The detection method according to claim 10, wherein the at least one detector comprises a plurality of directional detectors oriented in different directions, and
the detection method further comprises estimating, by a direction estimation unit, the direction of the sound source relative to a detection device, based on a magnitude relationship between levels of fundamentals included in sound waves detected by the respective detectors.
